(19) United States
(12) Patent Application Publication
(10) Pub. No.: US 2008/0216696 A1
(43) Pub. Date: Sep. 11, 2008

(54) DAMPING UNIT FOR A PRESS

(75) Inventors: Eduard Hoffmann, Bobingen (DE); Thomas Kandlbinder, Augsburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN Roland Druckmaschinen AG, Offenbach am Main (DE)

(21) Appl. No.: 12/038,618

(22) Filed: Feb. 27, 2008

Related U.S. Application Data
(62) Division of application No. 11/121,735, filed on May 3, 2005.

(30) Foreign Application Priority Data
May 5, 2004 (DE) 10 2004 022 084.0

(51) Int. Cl. B41F 33/00

(52) U.S. Cl. 101/484

(57) ABSTRACT

A damping unit for a press has means for applying a damping solution to a printing form and means for setting the quantity of damping solution applied. At least one sensor is provided for registering the quantity of damping solution actually applied to the printing form. By means of a comparison with a predefined quantity of damping solution, the quantity of damping solution on the printing form can be regulated.

### CROSS REFERENCE TO RELATED APPLICATIONS

This patent application is a divisional of U.S. application Ser. No. 11/121,735 filed on May 3, 2005 which claims priority to German Application No. 10 2004 022 084.0 filed May 5, 2004.

### FIELD OF THE INVENTION

The invention relates to printing devices, and more particularly to a damping unit for a printing press.

### BACKGROUND OF THE INVENTION

In planographic printing processes, it is generally known to wet the non-printing points of a printing form with damping solution and to wet the printing points with ink. The metering of the damping solution is controlled by the control desk. In the case of film damping units, the rotational speed of the damping solution distributor is driven and the quantity of damping solution across the web width is controlled manually by means of pressure changes between dip roll and damping solution distributor. In the case of nozzles and centrifugal damping units, the quantity of damping solution can be controlled via the spraying frequency of the nozzles or via the valve opening in the case of turbo damping units.

In the case of controlled metering of the quantity of damping solution, it is disadvantageous that erroneous settings can occur.

### BRIEF SUMMARY OF THE INVENTION

It is an object of the invention to improve the metering of the quantity of damping solution on a printing form.

In a damping unit according to the invention, the quantity of damping solution on the printing plate is advantageously regulated. Moreover, a damping unit according to the invention is advantageously self-teaching and compensates automatically for changes on the roll coatings as a result of swelling or shrinkage.

When starting up a new print job, the optimal settings can be stored, and, during the next such job, can be read back again into the control/regulating device of the damping unit as presetting data.

Furthermore, the laborious determination of what is known as a “damping run-up curve” for different materials can be dispensed with, since the rotational speed of the damping unit and, likewise, the imprint widths of the dip roll can be regulated via a control signal of the damping unit according to the invention.

Moreover, with a damping unit according to the invention, smearing, scumming and color build-up can be detected in good time and therefore the wastage can advantageously be reduced.

Preferred embodiments of the invention are described in greater detail below with reference to the schematic drawings, in which:

### BRIEF DESCRIPTION OF THE DRAWINGS

FIG. 1 shows a film damping unit in an embodiment according to the invention;

FIG. 2 shows adjusting devices of the film damping unit;

FIG. 3 shows a spray damping unit in another embodiment according to the invention; and

FIG. 4 shows a centrifugal damping unit in yet another embodiment according to the invention.

### DETAILED DESCRIPTION OF THE INVENTION

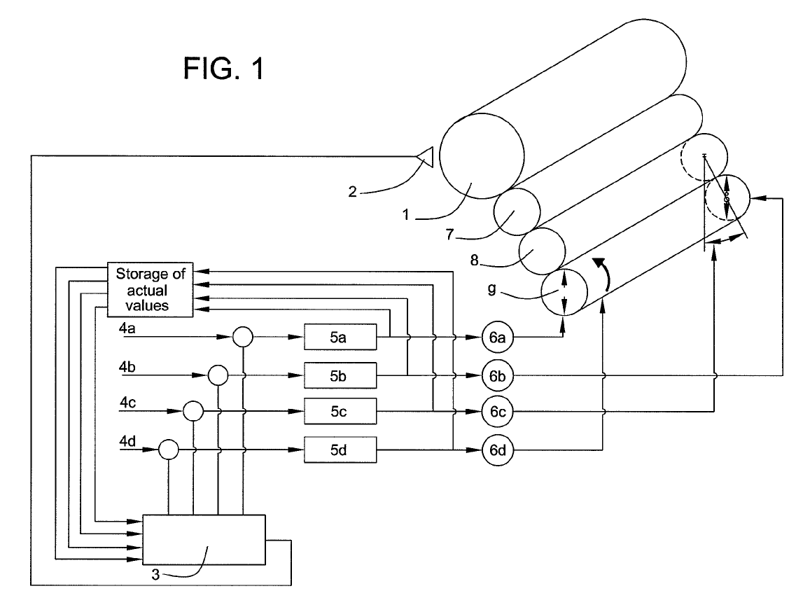

In FIG. 1, the principle according to the invention is applied to an embodiment using a film damping unit, illustrated as a detail from a press is a plate cylinder 1, which normally interacts with a transfer cylinder. On the plate cylinder 1 there is a printing form, which is provided with ink-accepting and ink-repelling regions. A damping solution is applied to the ink-repelling regions. In order to measure the damping solution layer thickness, a sensor 2 is provided, which is operatively connected to a control/regulating device 3. A value of the damping solution layer thickness or quantity can be predefined in the control and regulating device 3.

Since the quantity of damping solution which is applied to the plate cylinder 1 depends firstly on the pressure between a dip roll 9 and a damping solution distributor 8 and on the oblique adjustment of the dip roll with respect to the damping solution distributor and on the damping solution distributor speed, the predefined value 4 results in a set point for the pressure between the dip roll 9 and damping solution distributor, a set point for the oblique adjustment of the dip roll with respect to the damping solution distributor and a set point for the damping solution distributor speed. From the signal from the sensor 2, the control and regulating device 3 determines the respective actual values of the pressure between the dip roll and damping solution distributor, the actual value of the oblique adjustment of the dip roll and the damping solution distributor speed. Following a comparison between set points and actual values, the deviations determined are readjusted by means of appropriate regulating devices 5.

In order to adjust the pressure between the dip roll 9 and the damping solution distributor roll 8, two motors 6 a, b are provided, which are able to adjust the roll mountings, preferably via spindles. A further motor 6c is provided for the oblique adjustment of the dip roll, and a motor 6d is driven in order to regulate the damping solution distributor speed. The achievement of the predefined value 4 is manifested by the production of what is known as a good sheet. The latter has the desired print quality and the values for the control variables a, b, c and d adjusted for this purpose can be stored and later read back again into the control and regulating device 3 for the production of a similar job. Instead of a single sensor 2, a plurality of sensors 2 can also be provided, which are arranged distributed over the width of the printing form. The result is an evaluation of different regions of the printing form, and it is possible to regulate the corresponding regions differently as well.

In order to regulate to the predefined value 4, each control variable a, b, c, d can be regulated on its own or in conjunction with one or more others.

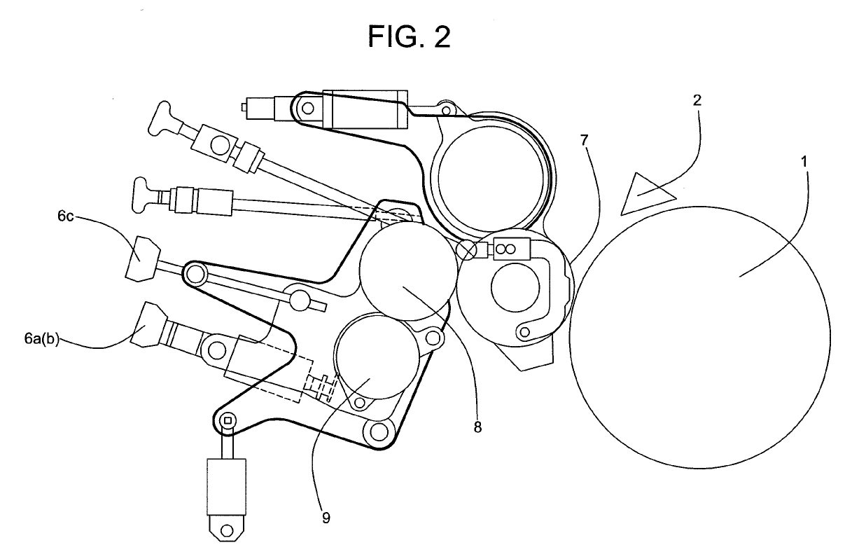

FIG. 2 illustrates the possible adjustments of the film damping unit in a side view. The dip roll 9 applies the damping solution to a damping solution distributor roll 8, which applies the damping solution to the printing form on the plate cylinder 1 via an applicator roll 7. In order to adjust the pressure between the dip roll 9 and the distributor roll 8, adjusting motors 6 a, b are provided, which are able to adjust the position of the roll mountings, preferably via spindles. For the purpose of adjusting the dip roll 9 obliquely with respect to the distributor roll 8, an adjusting motor 6c is provided, which likewise acts on the mounting of the dip roll 9, preferably via a spindle drive.

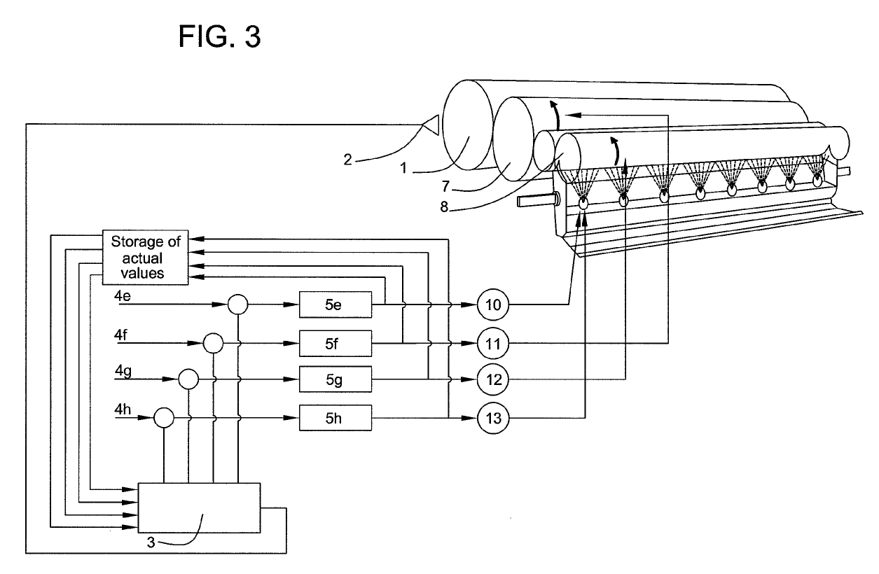

FIG. 3 illustrates an application of the principle according to the invention in an embodiment that uses a spray damping unit. In the case of a spray damping unit, the damping solution is sprayed via a spraying bar having a plurality of nozzles onto a damping solution distributor roll, which transfers the damping solution to the plate cylinder via a damping solution applicator roll. The quantity of damping solution may be influenced by the cycle frequency 10 and the cycle period 11 of the spraying. Furthermore, influence can also be exerted on the damping solution layer thickness via the damping solution distributor roll rotational speed 12 and the damping solution applicator roll rotational speed 13. As in the preceding exemplary embodiment, a sensor 2 is also provided here, which passes the actual value of the damping solution layer thickness on to a control/regulating device 3. The control and regulating device 3 breaks down the actual value into an actual value of the cycle frequency 10, cycle period 11, damping solution distributor rotational speed 12 and speed of the damping solution applicator roll 13. These actual values are compared with the associated set points i, f, g, h, which result from the predefined value of the quantity of damping solution. Following a comparison between the set points and the actual values, the corresponding deviations are readjusted. As soon as the first “good sheet” is produced, the ideal settings have been reached and' can be stored. These values are read back into the control and regulating device 3 again for the next similar job and used as predefined values for the various settings.

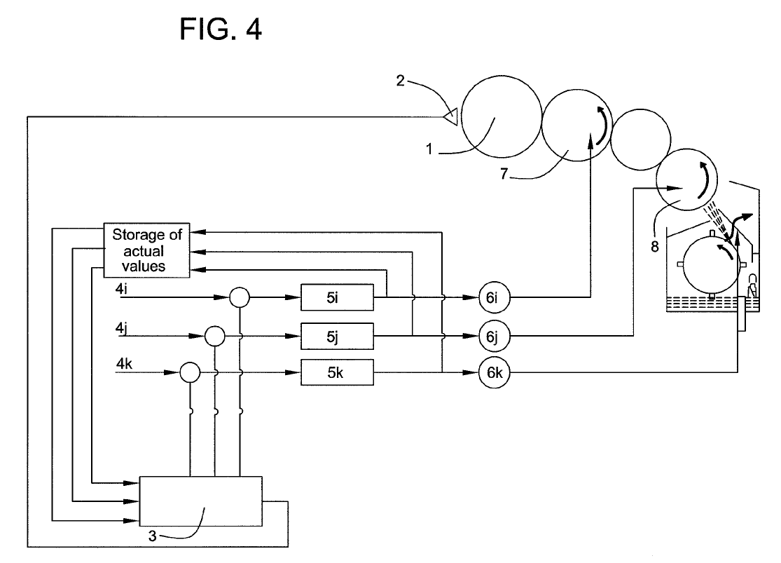

An embodiment of a centrifugal damping unit according to the invention is illustrated in FIG. 4. In the case of centrifugal damping units, the damping solution is thrown onto a damping solution distributor without contact by a rotor, or directly onto the plate cylinder 1. Adjustable shields are provided in order to meter the quantity of damping solution. It is also possible for the damping solution distributor rotational speed or the rotational speed of the damping solution applicator roll to be used for metering. As in the preceding exemplary embodiments, a sensor 2 determines the damping solution layer thickness on the plate cylinder 1, and passes it on to a control and regulating device 3. The control and regulating device 3 breaks down the actual value of the damping solution layer thickness into an actual value for the shield position, damping solution distributor rotational speed and the speed of the damping solution applicator roll. A predefined value for the quantity of damping solution can be entered into the control and regulating device, which is broken down into set points i, j, k for the shield position, damping solution distributor rotational speed and damping solution applicator roll rotational speed. Following a comparison between the individual set points and actual values, the various settings can be readjusted by controllers 5 i, j, k. As soon as the first good sheet is produced, the ideal settings have been reached and can be stored in a memory in order later to be read back in a manner analogous to the preceding exemplary embodiments.

1. A method of regulating a quantity of damping solution applied to a printing form via a printing press having a dip roll, a damping solution applicator roll for applying a damping solution to a printing form, at least one damping solution distributor roll for transferring the damping solution to the damping solution applicator roll, and a spraying device for spraying the damping solution onto the damping solution distributor roll at a spray cycle frequency and spray cycle duration, the method comprising:
applying a quantity of damping solution to the printing form; determining the quantity of damping solution applied to the printing form;
comparing the quantity of damping solution applied to the printing form with a predefined quantity associated with predefined settings for spraying frequency, spraying duration, rotational speed of the damping solution distributor roll and rotational speed of the damping solution applicator roll;
adjusting the spraying frequency, spraying duration, rotational speed of the damping solution distributor roll and rotational speed of the damping solution applicator roll to regulate the quantity of damping solution applied to the printing form toward a desired quantity; and
adjusting at least one of a pressure and an oblique adjustment of the dip roll with respect to at least one of the damping solution distributor roll and the damping solution distributor roll.

2. The method according to claim 1, wherein determining the quantity of damping solution applied to the printing form further comprises receiving a sensor signal from a plurality of sensors distributed over a width of the printing form.

3. The method according to claim 1, wherein adjusting at least one of a pressure and an oblique adjustment of the dip roll includes energizing motors for adjusting roll mountings of the dip roll and the damping solution distributor roll.

4. A method of regulating a quantity of damping solution applied to a printing form via a printing press having a dip roll, a damping solution applicator roll for applying a damping solution to a printing form, at least one damping solution distributor roll for transferring the damping solution to the damping solution applicator roll, and a spraying device for spraying the damping solution onto the damping solution distributor roll at a spray cycle frequency and spray cycle duration, the method comprising:
setting a first spray cycle frequency, first spray cycle duration, first damping solution distributor roll speed and first damping solution applicator roll speed;
spraying the damping solution with the spraying device onto the damping solution distributor roll consistent with the first spray cycle frequency and first spray cycle duration;
transferring the damping solution to the damping solution applicator roll via the damping solution distributor roll;
applying the damping solution to the printing form via the damping solution applicator roll;
determining the quantity of damping solution applied to the printing form and comparing the quantity with a predefined quantity of damping solution associated with a second spray cycle frequency, second spray cycle duration, second damping solution distributor roll speed and second damping solution applicator roll speed; and
iteratively adjusting the spray cycle frequency, spray cycle duration, damping solution distributor roll speed and damping solution applicator roll speed until an acceptable level of damping is observed associated with a third spray cycle frequency, third spray cycle duration, third damping solution distributor roll speed and third damping solution applicator roll speed.

5. The method according to claim 4, further comprising storing control values including the third spray cycle frequency, third spray cycle duration, third damping solution distributor roll speed and third damping solution applicator roll speed to read back the control values for executing a subsequent print job.
